(19) United States
(12) Patent Application Publication
(10) Pub. No.: US 2005/0007099 A1
(43) Pub. Date: Jan. 13, 2005

(54) Position sensing method and apparatus for a linkage system

(76) Inventors: Arun M. Hamasagar, Plainfield, IL (US); Thomas G. Skinner, Bolingbrook, IL (US)

Correspondence Address: CATERPILLAR INC.;100 N.E. ADAMS STREET, PATENT DEPT., PEORIA, IL, 616296490, US

(21) Appl. No.: 10/614,526

(22) Filed: Jul. 7, 2003

(51) Int. Cl. G01P 3/36

(52) U.S. Cl. 324/175

(57) ABSTRACT

A position sensor assembly adapted to mount externally to a linkage system may comprise first and second sensor housing members and first and second sensor portions. The first housing member may be adapted for external connection to the linkage system, may have a first sensor conduit therein, and may be configured and arranged to at least partially enclose the first and second sensor portions. The second sensor housing member may be slidably received within the first sensor housing member and may have a second sensor conduit therein. The first sensor portion may be connected with the first sensor housing member, and the second sensor portion may be connected with the second sensor housing member. The position sensor assembly may be operable to register a position of the first sensor portion relative to the second sensor portion as a result of cooperation between the first and second sensor portions.

### TECHNICAL FIELD

This invention relates to a position sensing method and apparatus for a linkage system and, more particularly, for sensing the position of a first linkage member relative to a second linkage member.

### BACKGROUND

Known linkage systems, such as those using fluid cylinders to change linkage length and angular orientation, typically utilize controls wherein information relating to linkage length and/or velocity of linkage movement is required. The electrical aspects of control apparatus for such systems generally require the use of a variety of sensors, including, but not limited to, linkage position sensors, and may also utilize electro-hydraulic valves and/or an onboard electronic control module operable for executing a control strategy for linkage movement. Such control strategies often comprise a linkage position input that may be embodied, for instance, in positional and/or velocity information relating to one of the linkage members, such as a cylinder rod. Such positional and velocity information may be collected, for example, by a position sensor coupled to the cylinder rod.

Reliable and accurate data collection from such sensors has been found to be largely dependent upon the ability to maintain the integrity of the sensors under adverse operating and environmental conditions, such as heat, cold, dust, dirt, and contact with rocks, debris, and other objects or factors that can damage the sensor and/or its path of communication with other elements of the control system. In order to reduce the potential for sensor damage resulting from such operating and environmental factors, one or more sensor components may be encased directly within a cylinder housing or body. However, internal mounting of sensor componentry may subject the componentry to increased pressures or temperatures and may undesirably increase the deadlength of the cylinder in which it is embedded. In addition, such internal sensor systems may be inappropriate for use with linkage components having small internal dimensions.

Moreover, the recent advance in position sensing technology, e.g., accuracy, has produced a need to retrofit old or existing hydraulic cylinders and other linkage systems with such position sensing technology. For example, an earthmoving machine fitted with a Global Positioning System (GPS) may provide added benefits if retrofitted with an accurate, reliable, and robust position sensor assembly. However, many existing position sensor assemblies, such as internally oriented sensor systems, are often difficult or expensive to retrofit to existing cylinders since disassembly, replacement, or machining of significant cylinder or other linkage components may be required. Further, many existing position sensor assemblies require very particular mounting configurations relative to linkage systems, and the versatility of such assemblies may be limited by these mounting requirements.

U.S. Pat. No. 5,717,330 issued to Moreau et al. discloses a magnetostrictive linear displacement transducer that may be mounted internally to the piston of a hydraulic cylinder. Moreau discloses a transducer having transducer componentry mounted inside a hydraulic cylinder. In one embodiment, a magnet is mounted on a piston inside the hydraulic cylinder, and a coil is mounted on the exterior of the cylinder. Such a device incorporates one or more of the disadvantages described above. For example, the device provides limited adaptability since the cylinder must be formed of a non-ferromagnetic material in order for the device to function properly. Moreover, it should be appreciated that the coil of such a device, even though externally mounted relative to the cylinder, must be disposed very close to or in contact with the cylinder in order to produce the desired interaction between the externally mounted coil and the internally mounted magnet. Further, the disclosed arrangement may limit or prevent the adaptability of the device to a cylinder lacking a flat or linear outer surface or a cylinder having external componentry disposed about its outer surface that would interfere with or prevent positioning the coil along and in contact with the cylinder.

Other existing position sensor assemblies, such as cable extension transducers or “yo-yo sensors”, may provide mounting flexibility but may be less accurate than desired when used in challenging environments. One example of a cable extension transducer includes a transducer housing that encloses a spring-loaded spool about which is wrapped a flexible stainless steel cable. The housing may be mounted to a fixed surface, and one end of the cable may be mounted to a movable object. As the object moves relative to the fixed surface, the spool rotates to release or retract the cable as necessary and the transducer produces an electrical signal that is proportional to the rotation of the spool and the extension or retraction distance of the cable. However, during certain conditions, such as high temperature and/or high-speed operations, the cable may stretch or the spool may not retract quick enough, thereby causing inaccuracies in the transducer's reading. Moreover, the cable or other components of the cable extension transducer may be susceptible to damage from environmental factors, such as debris or falling rock, for example.

Accordingly, the present invention is directed to overcoming one or more of the problems set forth above.

### SUMMARY OF THE INVENTION

According to one aspect of the invention, a position sensor assembly adapted to mount externally to a linkage system may comprise first and second sensor housing members and first and second sensor portions. The first sensor housing member may be adapted for external connection to the linkage system, may have a first sensor conduit therein, and may be configured and arranged to at least partially enclose the first and second sensor portions. The second sensor housing member may be slidably received within the first sensor housing member and may have a second sensor conduit therein. The first sensor portion may be connected with the first sensor housing member, and the second sensor portion may be connected with the second sensor housing member. The position sensor assembly may be operable to register a position of the first sensor portion relative to the second sensor portion as a result of cooperation between the first and second sensor portions.

According to another aspect of the invention, a linkage and sensor system may comprise a first linkage member and a second linkage member movably connected to the first linkage member. The system may further comprise a position sensor assembly externally connected to the first and second linkage members. The position sensor assembly may comprise first and second sensor housing members and first and second sensor portions. The first sensor housing member may be externally connected with one of the first and second linkage members, may have a first sensor conduit therein, and may be configured and arranged to at least partially enclose the first and second sensor portions. The second sensor housing member may be externally connected to the other of the first and second linkage members, may be slidably received within the first sensor housing member, and may have a second sensor conduit therein. The first sensor portion may be connected with the first sensor housing member, and the second sensor portion may be connected with the second sensor housing member. The position sensor assembly may be operable to register a position of the first linkage member relative to the second linkage member as a result of cooperation between the first and second sensor portions.

According to a further aspect of the invention, a linkage and sensor system may comprise a first linkage member, a second linkage member movably connected to the first linkage member, and a self-aligning position sensor assembly connected with the first and second linkage members. The position sensor assembly may comprise a first sensor portion, a second sensor portion, a sensor housing member, and at least one self-aligning mounting member. The first sensor portion may be operatively connected to the first linkage member, and the second sensor portion may be operatively connected to the second linkage member. The sensor housing member may at least partially enclose at least one of the first and second sensor portions. The at least one self-aligning mounting member may connect the sensor housing member externally to the first linkage member and may be operable to align the sensor housing member in a predetermined orientation relative to the first linkage member during assembly of the sensor housing member with the first linkage member. The position sensor assembly may be operable to register a position of the first linkage member relative to the second linkage member as a result of cooperation between the first and second sensor portions.

According to yet another aspect of the invention, a method of determining the position of a first linkage member relative to a second linkage member is provided. The method may include adapting the first linkage member with a first sensor portion that is at least partially enclosed by a first sensor housing member. The method may also include adapting the second linkage member with a second sensor portion that is connected to a second sensor housing member and that is at least partially enclosed by the first sensor housing member. The first and second sensor portions and the first and second sensor housing members may be externally disposed relative to the first and second linkage members. In addition, the first sensor portion may be configured in a telescopically movable relationship relative to the second sensor portion. The method may further include moving the first linkage member relative to the second linkage member and causing the first sensor housing member to enclosingly and slidably receive the second sensor housing member. Thus, the position sensor assembly may be caused to register a position of the first linkage member relative to the second linkage member as a result of cooperation between the first and second sensor portions.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several exemplary embodiments of the invention and, together with the description, serve to explain the principles of the invention. In the drawings,

FIG. 1 is a perspective view of an embodiment of a linkage and sensor system including a linkage system and a position sensor assembly;

FIG. 2 is a cross-sectional view of the linkage and sensor system of FIG. 1;

FIG. 3A is a partial perspective view of a sensor system including an alternative attachment arrangement and an alternative module housing member arrangement;

FIG. 3B is a partial cutaway perspective view of a linkage and sensor system having an alternative attachment mechanism for the position sensor assembly;

FIG. 4 is an enlarged partial perspective view of the mounting arm and connecting pin of the linkage and sensor system shown in FIG. 1;

FIG. 5 is a cross-sectional view of an alternative embodiment of a linkage and sensor system;

FIG. 6 is an enlarged partial cross-sectional view of one end of the first housing member shown in FIG. 2; and

FIG. 7 is an enlarged partial cross-sectional view of one end of the second housing member shown in FIG. 2.

Although the drawings represent several embodiments of the present invention, the drawings are not necessarily to scale, and certain features may be exaggerated in order to better illustrate and explain the present invention.

The exemplifications set out herein illustrate exemplary embodiments of the invention and such exemplifications are not to be construed as limiting the scope of the invention in any manner.

### DETAILED DESCRIPTION

Reference will now be made in detail to embodiments of the invention, examples of which are illustrated in the accompanying drawings.

Wherever possible, the same or corresponding reference numbers will be used throughout the drawings to refer to the same or corresponding parts.

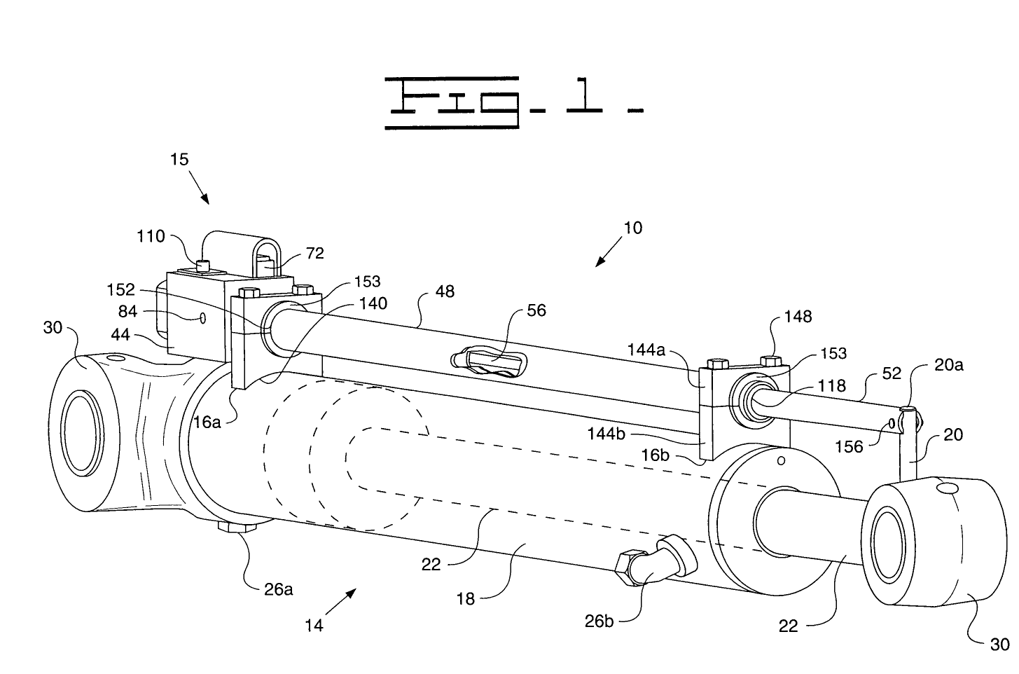

FIG. 1 shows an exemplary position sensor assembly 10 combined with an exemplary linkage system 14, the combination forming an exemplary linkage and sensor system 15. The position sensor assembly 10 may be externally connected to the linkage system 14 by one or more mounting members 16a, 16b and/or mounting arm(s) 20, each of which will be described in greater detail hereinbelow.

The illustrated linkage system 14 includes a first linkage member, such as a fluid cylinder 18, and a second linkage member, such as a piston and rod assembly 22 reciprocally disposed within the fluid cylinder 18. It should be appreciated that the terms “first linkage member” and “second linkage member” are used herein for explanatory purposes and may be interchangeably applied to the piston and rod assembly 22, the cylinder 18, and/or various other components of a linkage system. Moreover, the linkage system 14 may, alternatively or in addition, comprise different components or linkage members, such as a frame, bucket, or other implements or components of an earthmoving machine, each of which may be referred to as a “first linkage member” or a “second linkage member.”

The cylinder 18 illustrated in FIG. 1 includes fluid ports 26a, 26b for the administration of pressurized fluid to one or more internal portions of the fluid cylinder 18. One skilled in the art will appreciate that controlled administration of a pressurized fluid, such as hydraulic fluid, internally to the fluid cylinder 18 via one or more fluid ports 26a, 26b causes extension and retraction of the piston and rod assembly 22 relative to the fluid cylinder 18. One or more mounting ends 30 may be provided at one or both ends of linkage system 14 to facilitate connection of the linkage system 14 to one or more additional linkage members (not shown), such as various implements or other components of earthmoving machines, compactors, or rams, for example. It should be appreciated that the cylinder 18 may be formed from ferrous materials, such as steel for example, or may be formed from non-ferrous materials if desired.

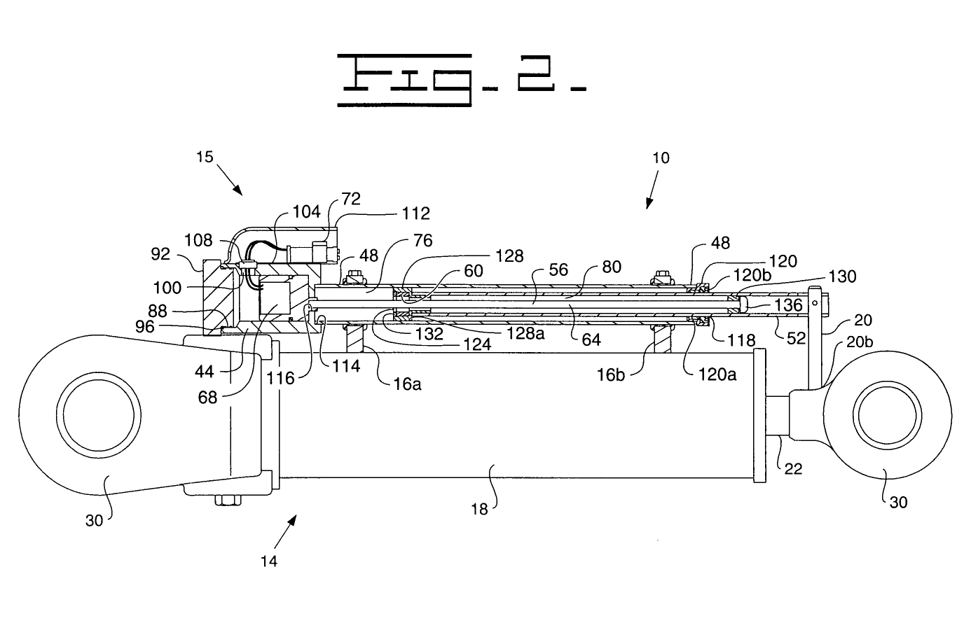

The position sensor assembly 10 shown in FIG. 1 includes a first housing member 48, such as an outer sensor tube body, which may be configured and arranged to enclose various portions of the position sensor assembly 10 and to, therefore, protect such portions from potentially adverse operating and environmental conditions. The first housing member 48 may be operably connected to the cylinder 18 of the linkage system 14. The position sensor assembly 10 may further include a second housing member 52 or sensor member, such as an inner sensor tube body. The second housing member 52 may be telescopically received within the first housing member 48 in one aspect and operably connected to a component 22 of the linkage system 14 in another aspect. In one exemplary embodiment, the housing members 48, 52 connect linkage members—such as the cylinder 18 and the piston and rod assembly 22—to first and second sensor portions 56, 60 (FIG. 2), respectively. It should be appreciated that the terms “first sensor portion” and “second sensor portion” are used herein for explanatory purposes and may be interchangeably applied to various components of the position sensor assembly 10, such as a pressure pipe/waveguide (56) and a magnet (60), as illustrated in FIG. 2.

The sensor components of the position sensor assembly 10 may vary as conditions require or as desired by a user. For example, the sensor components may form a resistive type sensor, a capacitive type sensor, a magnetostrictive type sensor, an inductive type sensor, or some other type sensor known in the art. The position sensor assembly 10 shown in FIG. 2 comprises a magnetostrictive type sensor 64 for determining the position of the piston and rod assembly 22 relative to the fluid cylinder 18. The sensor 64 includes a first sensor portion 56 operably connected with at least one component of the linkage system 14 and extending axially within a passage or conduit 76 of the first housing member 48. The first sensor portion 56 may also be telescopically received within a passage or conduit 80 of the second housing member 52. Such an arrangement allows the first sensor portion 56 to be embedded deeply within the position sensor assembly 10 for greater protection of the first sensor portion 56 from external conditions.

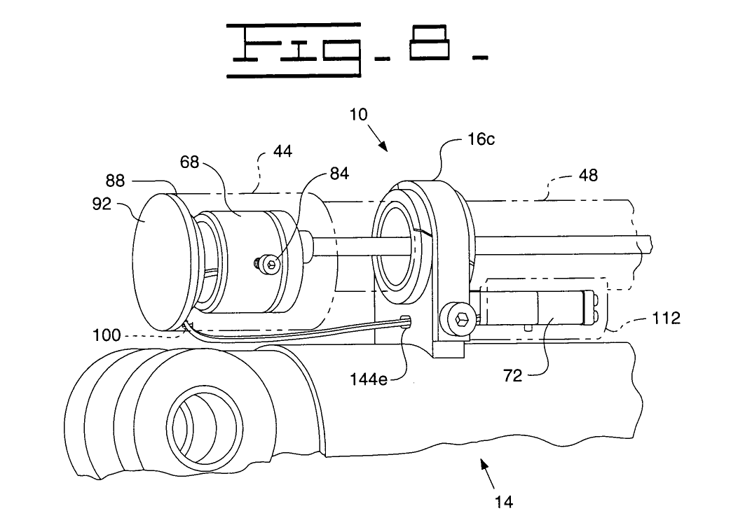

The first sensor portion 56 illustrated in FIG. 2 contains a magnetostrictive element or waveguide (not shown) that extends through the first sensor portion 56 and interacts with an interactive second sensor portion 60, such as a magnet. The second sensor portion 60, which may be connected with the second housing member 52, is configured and arranged to be movable relative to the first sensor portion 56. For example, as illustrated in FIGS. 2 and 7, the second sensor portion 60 may have an annular or semi-annular configuration and may be movably arranged in a telescopic configuration relative to the first sensor portion 56.

Referring again to the embodiment shown in FIG. 2, the first sensor portion 56 is electrically connected to the sensor 64. The sensor 64 further comprises a current generator (not shown) operable for generating current pulses, which are sent through the first sensor portion 56. The second sensor portion 60 encircles the first sensor portion 56 and provides a magnetic field that interacts with the current pulse. This interaction causes within the first sensor portion 56 a torsional pulse that is transmitted back to the sensor 64 as a torsional strain wave having a time period. The torsional strain wave is sensed by a mode converter or other conventional sensor element (not shown) in the sensor 64, which generates an output wave signal in response to the torsional strain wave. The output wave signal is then communicated to a sensor electronics module 68, which compares the time of receipt of the output wave signal to the time of launch of the initial current pulse to determine the position of the second sensor portion 60 relative to the first sensor portion 56 and to output a position signal representative thereof. The position signal is transferred or communicated to a control center, such as an electronic control module (ECM) (not shown), for example, through the connector 72 and associated wires. As shown in FIG. 2, the sensor electronics module 68 may be enclosed within a module housing member 44. In an alternative embodiment, the sensor electronics module 68 may be configured and arranged in a different location or orientation, such as being disposed at a location distant from the sensor 64.

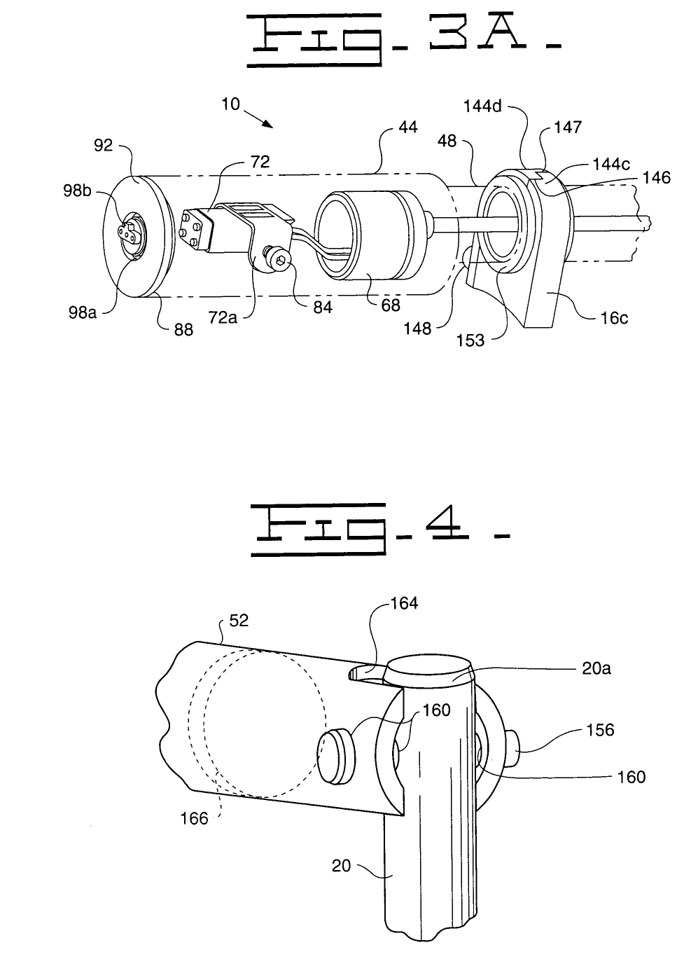

The position sensor assembly 10 shown in FIGS. 1 and 2 includes a module housing member 44 disposed at one end of the position sensor assembly 10. The module housing member 44 may provide an internal cavity for receipt and protection of the sensor electronics module 68. The module housing member 44 may have a rectangular cross-section (as illustrated in FIG. 1) or may, alternatively, have a circular or otherwise non-rectangular cross-section as desired. For example, FIGS. 3A and 8 show alternative embodiments having a module housing member 44 with a generally circular cross section. Such housing members 44 may be formed, for example, from steel tubing or from steel round bar material. It should be appreciated that the module housing member 44 may comprise a flange portion having a threaded area thereon. The flange portion may be welded or otherwise connected to the first housing member 48, and the sensor module 68 may be screwed into the flange portion via complimentary threads disposed on the sensor module 48.

Referring to FIGS. 2, 3A, and 8, the sensor module 68 may be press-fit inside the internal cavity of the module housing member 44 or may be secured inside the module housing member 44 by a set screw 84 (shown in FIGS. 1 and 8), by complimentary threads disposed on the sensor module 68 and the module housing member 44, or by one or more additional or alternative attachment mechanisms known in the art. The module housing member 44 may include an opening 88 for accessing or removing the sensor module 68 as desired. A removable plug member 92 may be applied to the module housing member 44 for selectively closing the opening 88. The plug member 92 may be attached to the module housing member 44, for example, by complimentary threading formed on the plug member 92 and the module housing member 44 or by a press fit configuration therebetween, and a gasket 96 may be provided between the plug member 92 and the module housing member 44 to seal the connection therebetween.

It should be appreciated from the foregoing discussion and the referenced figures that the sensor module 68 may be securely encased within the position sensor assembly 10 (e.g., within module housing member 44) to significantly reduce the likelihood of damage to the sensor module 68 and/or compromise of the sensor function during operation of the position sensor assembly 10. It should further be appreciated that the disclosed embodiments may provide such protection for the sensor module 68 while also allowing convenient access to the sensor module 68.

An orifice 100 may be provided in the wall of the module housing member 44 for passage of the connector wiring and/or the connector 72 therethrough during assembly or maintenance operations. It should be appreciated that the orifice may, alternatively or additionally, be provided in the plug member 92. In the embodiment of FIGS. 1 and 2, a mounting plate 104 and a mounting bracket 108 are attached to the module housing member 44 for securing the connector 72 and its associated wiring to the module housing member 44. A connector cover 112 for protecting the connector 72 and its associated wiring from external factors may also be attached to the module housing member 44 by one or more screws or bolts 110, for example.

In a first alternative embodiment (FIG. 8), the connector 72 may be attached to the exterior of the housing member 48, such as underneath the housing member 48 between the housing member 48 and the linkage system 14. In addition, a connector cover 112 may be provided to cover the connector 72 and its associated wiring and to provide additional protection thereto. Moreover, in such an embodiment, an orifice 144e may be provided within the mounting member 16c for passage of the connector wiring and/or the connector 72 therethrough.

In a second alternative embodiment (FIG. 3A), the connector 72 may be at least partially encased within the module housing member 44 to provide additional protection for the connector 72 from external factors. For example, a mounting bracket 72a connected to the connector 72 may be connected to an interior portion of the module housing member 44, such as with a set screw 84, for securing the connector 72 at least partially inside the module housing member 48. Further, an orifice 98a may be provided within the plug member 92 (and/or within the housing member 44) for passage of a mating connector (not shown) therethrough to be connected with the connector 72. Alternatively, the connector 72 may be at least partially disposed and arranged inside the orifice 98a to allow connection of an external mating connector (not shown) thereto. Moreover, a cap member 98b may be provided inside the orifice 98a for at least partially closing the orifice 98a.

The module housing member 44 may further include a bore 114 for receipt of the first housing member 48. The first housing member 48 may be secured to the module housing member, for example, by a press-fit configuration with the bore 114, by complimentary threads disposed on the first housing member 48 and the bore 114, by a welded connection, by a flange-type connection, or by a variety of additional or alternative mechanisms known in the art. The module housing member 44 may also include a sensor port 116 formed through a wall of the module housing member 44 to allow the first sensor portion 56 to extend through the wall of the module housing member 44 and into a left end (as viewed from the perspective shown in FIG. 2) of the first housing member 48. As mentioned above, the first housing member 48 may generally define or form an internal passage or conduit 76, through which the first sensor portion 56 may extend toward a right end (as viewed from the perspective shown in FIG. 2) of the first housing member 48.

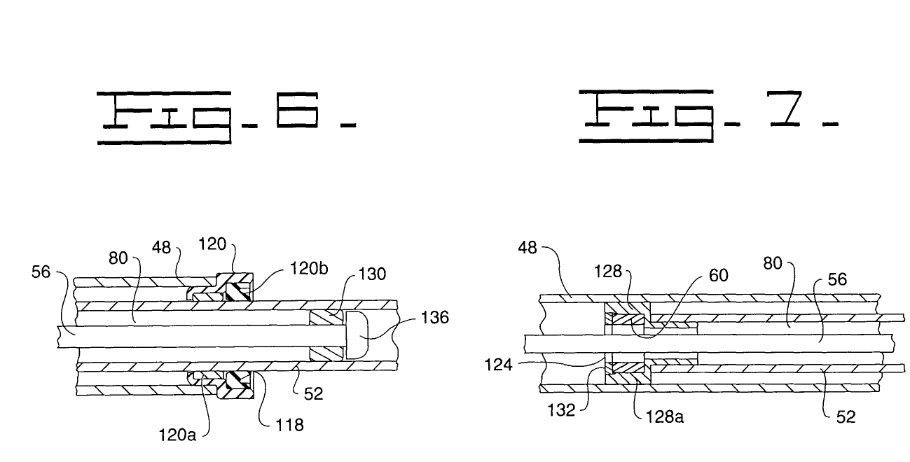

Referring to FIGS. 2 and 6 and referencing the right end of the first housing member 48, an opening 118 may be formed in the first housing member 48 for receipt of the second housing member 52. The conduit 76 and the opening 118 each may have a generally circular cross-section, as illustrated in FIG. 1, or a generally noncircular cross-section, such as, for example, a generally rectangular or triangular cross-section, as desired.

FIG. 6 shows a guide member 120, which may be attached to the first housing member 48 at its opening 118, for example, and which may be configured and arranged to ensure or at least facilitate a snug and slidable interface between the first housing member 48 and the second housing member 52. A contact portion 120a of the guide member 120 may be formed from acetal, polyoxymethylene, or some other plastic or like material so that the guide member 120 has a high wear resistance and so that little or no lubrication is required for smooth interaction between the guide member 120 and the second housing member 52 during operation of the position sensor assembly 10. Guide member 120 may further comprise a flexible member or wiper element 120b formed, for example, from a rubber material and having an internal diameter slightly smaller than the outer diameter of the second housing member 52. The flexible member 120b may be designed to deform as necessary during operation to ensure a snug interface between the two housing members 48, 52 and may be configured to perform a wiper function over the outer surface of the second housing member 52 to prevent, limit, or at least inhibit moisture, dirt, or other factors from entering the second housing member 52 during operation. The guide member 120 may be attached to the first housing member 48 by a press-fit configuration (as shown in FIG. 6), by complimentary threads disposed on the guide member 120 and the first housing member 48, or by other attachment mechanisms known in the art.

The second housing member 52 may be slidably received within the opening 118 of the first housing member 48. Moreover, as illustrated in FIGS. 2 and 7, the second housing member 52 may define or form an internal passage or conduit 80. The second housing member 52 may further have an opening 124 at one end thereof for slidably receiving the first sensor portion 56 into the conduit 80. It should be appreciated that the conduit 80 may have either a generally circular cross-section, as illustrated in FIG. 1, or a generally noncircular cross-section, such as a generally rectangular or triangular cross-section, as desired.

Referring again to FIGS. 2 and 7, a guide member 128 may be attached to the second housing member 52, for example at the opening 124, and may be configured and arranged to ensure or at least facilitate a snug and slidable interface between the second housing member 52 and the first housing member 48. The guide member 128 may be attached to the second housing member 52 by a press-fit configuration (as shown in FIG. 7), by complimentary threads disposed on the guide member 128 and the second housing member 52, or by other attachment mechanisms known in the art. At least a portion 128a of the guide member 128 may be formed from acetal, polyoxymethylene, or some other plastic or like material so that the guide member 128 has a high wear resistance and so that little or no lubrication is required for smooth interaction between the guide member 128 and the first housing member 48 during operation of the position sensor assembly 10.

As illustrated in FIG. 2, the first sensor portion 56 may be at least partially arranged within and enclosed by the conduit 76 of the first housing member 48. Moreover, the first sensor portion 56 may be configured to move with the first housing member 48. For example, the first sensor portion 56 shown in FIG. 2 is secured to or integrally formed with the sensor module 68. The sensor module 68 is secured to the module housing member 44, which is secured to the first housing member 48. Thus, the first sensor portion 56 of FIG. 2 is generally suspended within and configured to move with the first housing member 48. It should be appreciated that, in an alternative embodiment, the first sensor portion 56 may be attached directly to the module housing member 44 or to the first housing member 48.

Referring to FIG. 2, the first sensor portion 56 may be slidably received within the conduit 80 of the second housing member 52 through opening 124. The first sensor portion 56 may include a guide member 130 (FIG. 6) disposed within the conduit 80 between the first sensor portion 56 and the second housing member 52. The guide member 130 may be configured and arranged about the first sensor portion 56 to prevent, limit, or at least inhibit contact—or the transmission of force between—the first sensor portion 56 and the second housing member 52. For example, the guide member 130 may have a larger outer diameter than the first sensor portion 56. In addition or alternatively, the member 130 may function as a stopper to prevent or inhibit the inadvertent removal of the first sensor portion 56 from within the conduit 80 during operation. For example, the outer diameter of the member 130 may be sized larger than the inner diameter of the opening 124. The member 130 may be affixed to, or integrally formed with, the first sensor portion 56 by a press-fit configuration, by a threaded bolt 136, which may be screwed into a threaded opening (not shown) within the first sensor portion 56, or by some other attachment mechanism known in the art. It should be appreciated that the member 130 and the bolt 136 may be integrally formed into a single unit. The guide member 130 may be formed from such materials as plastic, rubber, or other suitable materials known in the art.

As illustrated in FIGS. 2 and 7, a sensor portion 60, such as a magnet, may be attached to the second housing member 52 and may be at least partially enclosed by the second housing member 52 or the guide member 128. The second sensor portion 60 may be attached to the guide member 128, which is secured to the second housing member 52. Alternatively, the second sensor portion 60 may be directly attached to the second housing member 52. Thus, the second sensor portion 60 may be configured to move with the second housing member 52 so that relative movement between the second housing member 52 and the first housing member 48 causes relative movement between the second sensor portion 60 and the first sensor portion 56. The second sensor portion 60 may be attached to the guide member 128 in a variety of ways, such as by a press-fit configuration, by mating threads formed on the second sensor portion 60 and the guide member 128, or by alternative or additional attachment mechanisms known in the art. For example, the embodiment shown in FIG. 7 includes a press ring 132, which is affixed to the guide member 128 by a press-fit configuration to ensure that the second sensor portion 60 is secured within the guide member 128.

Referring to FIG. 1, the position sensor assembly 10 may be attached to the linkage system 14 by one or more mounting members 16a, 16b and/or one or more mounting arm(s) 20. For example, the first housing member 48 may be attached externally to one of the linkage system components, such as the cylinder 18, by a mounting member 16a, 16b having a contoured mounting surface 140. As illustrated in FIGS. 1 and 2, multiple mounting members 16a, 16b may be used as desired. It should be appreciated that, in an alternative embodiment, the second housing member 52 may be attached to one of the linkage system components, such as the cylinder 18, by a mounting member 16a, 16b.

As shown in FIG. 1, the contoured mounting surface 140 of at least one of the mounting members 16a, 16b may be configured to self-align with one of the components of the linkage system 14, such as the outer surface of the cylinder 18, to facilitate connection of the position sensor assembly 10 in a predetermined orientation relative to the linkage system 14. For example, the contoured mounting surface 140 may provide a curved area that generally mates with the outer circumferential curvature of the wall of the cylinder 18. Thus, upon application of the contoured mounting surface 140 to the cylinder 18, the mounting member 16a, 16b—and, therefore, the position sensor assembly 10—may be quickly and automatically aligned with the cylinder 18 as desired. Moreover, as shown in FIG. 1, the contoured mounting surface 140 may be configured to facilitate attachment of the first housing member 48 to the cylinder 18 in a generally parallel and spaced apart orientation. Such a self-aligning mounting member 16a, 16b may simplify mounting of the position sensor assembly 10 to the linkage system 14, especially during on-site assembly operations—i.e., when precision alignment tools may not be accessible. In order to ensure an accurate and tight alignment of the position sensor assembly 10 with the cylinder 18, the curvature of the contoured mounting surface 140 may have a slightly smaller radius of curvature than that of the cylinder 18.

As illustrated in FIG. 1, mounting members 16a, 16b may comprise top and bottom mounting portions 144a, 144b, which may be secured together by one or more screws or bolts 148 or by other attachment mechanisms known in the art. The top and bottom mounting portions 144a, 144b may each include a generally semicircular contour for mating with a generally cylindrical housing member 48. As indicated in FIG. 3A, alternative configurations for a mounting member 16c are also envisioned. For example, a mounting member 16c may include front and rear mounting portions 144c, 144d. The mounting portions 144c, 144d may include notched or otherwise contoured areas 146, 147 for complimentary engagement and for simplified and secured alignment of the mounting portions 144c, 144d. The front and rear mounting portions 144c, 144d may be secured together by one or more screws or bolts 148 or by other attachment mechanisms known in the art. With the embodiments described above, a mounted but untightened housing member 48 may be rotated relative to the mounting members 16a, 16b, 16c until the position sensor assembly 10 is in a desired orientation relative to linkage system 14. Bushings 153 or grommets, such as rubber grommets, may be provided between the mounting portions 144a, 144b, 144c, 144d and the secured position sensor componentry to prevent or at least inhibit vibration of the position sensor componentry during operation and/or to ensure a tight fit between the mounting portions 144a, 144b, 144c, 144d and the secured position sensor componentry.

Each mounting member 16a, 16b may be secured to the linkage system 14 via, for example, a welded connection (FIG. 1) or a strap 150 (FIG. 3B), which may be secured tightly around the mounting member 16a, 16b and the linkage system component 18 to which the mounting member 16a, 16b is attached. When a strap 150 is used, the upper mounting portion 144a may further comprise a contoured portion 152 defining a channel for receipt of the strap 150. Such straps 150 may be formed, for example, from sheet metal and may be secured and tightened, for example, with a conventional nut and bolt configuration generally referenced as 151 in FIG. 3B.

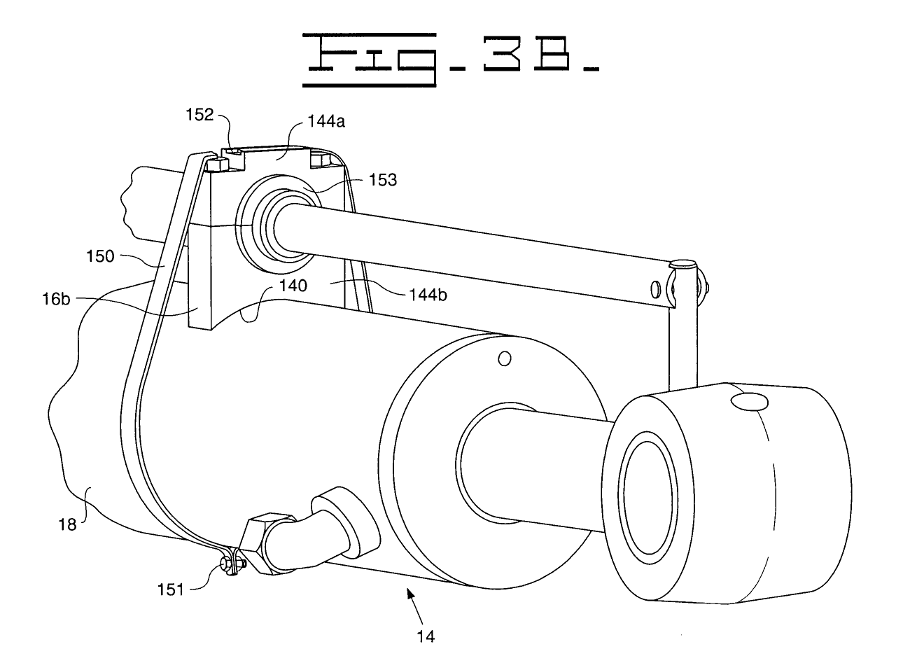

Referring to FIGS. 2 and 4, a mounting arm 20 may also be used to attach one of the position sensor assembly components to one of the linkage system components. For example, with reference to FIG. 4, an end 20a of the mounting arm 20 may be movably attached to an end of the second housing member 52. A pin 156 may be inserted through holes 160 in a first end 20a of the mounting arm 20 and through holes 160 in an end of the second housing member 52 so that the mounting arm 20 is rotatably connected to the second housing member 52. In addition, notches 164 may be formed in the second housing member 52 to allow pivotal movement of the mounting arm 20 relative to the second housing member 52. In alternative embodiments, the holes 160 may be elongated slots. For example, the holes 160 in the second housing member 52 may be elongated in a direction transverse to the length of the second housing member 52 to allow limited transverse movement of the second housing member 52 relative to the mounting arm 20.

Referring to FIG. 2, a second end 20b of the mounting arm 20 may be attached to one of the linkage system components, such as the piston and rod assembly 22 or a mounting end 30, so that the mounting arm 20 operably connects the position sensor assembly 10 to the linkage system 14. The attachment mechanism between the mounting arm 20 and the linkage system 14 may comprise, for example, a welded connection (as shown in FIG. 2), threads disposed on the mounting arm 20 that engage complimentary threads disposed on the piston and rod assembly 22, or various other attachment mechanisms known in the art.

As shown in FIG. 4, the interior of the second housing member 52 may be sealed off from the environment on at least one end, for example with a cap member 166 disposed inside the second housing member 52, to further protect the sensor componentry from external factors. The cap member 166 may be connected to, or integrally formed with, the second housing member 52 with an adhesive, a welded connection, a press-fit connection, or with any of a variety of connection mechanisms known in the art.

Referring to FIG. 1, during an assembly of the position sensor assembly 10 with the linkage system 14, the first housing member 48 may be secured to the linkage system 14, for example to the cylinder 18, by one or more mounting members 16a, 16b. The second housing member 52 may then be arranged at a desired location relative to linkage system 14 and attached to the linkage system 14 via the mounting arm 20. For example, as shown in FIG. 1, the mounting arm 20 may be attached between the second housing member 52 and the piston and rod assembly 22. If required, the mounting arm 20 may be shortened or rotated relative to the second housing member 52 during the assembly operation in order to ensure proper alignment of the second housing member 52 relative to the first housing member 48 and the linkage system 14.

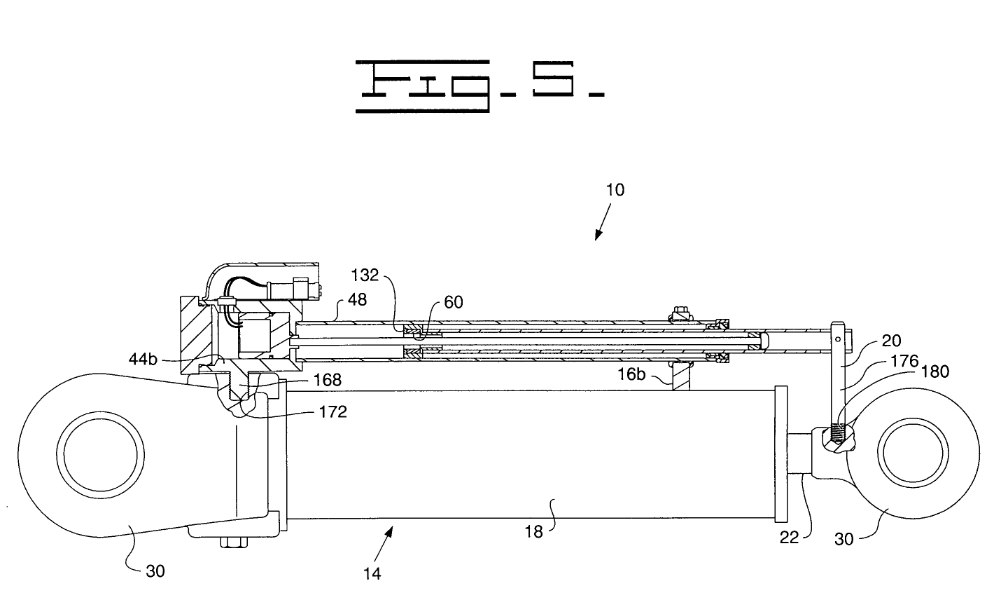

It should be appreciated that the position sensor assembly 10 may be attached to the linkage system 14 by alternative or additional attachment mechanisms. For example, as illustrated in FIG. 5, one of the position sensor assembly components, such as the module housing member 44b, may be connected directly to a mounting end 30. The module housing member 44b may comprise an external mounting extension 168 that is received within a bore 172 formed in the mounting end 30. The extension 168 and the bore 172 may be provided with complimentary threads for securing the extension 168 to the bore 172. Similarly, the extension arm 20 may be provided with an extension 176 for receipt within a bore 180 of a mounting end 30. It should be appreciated that the housing member 44b may, alternatively or in addition, be strapped or welded directly to the mounting end 30 or attached to the mounting end 30 by other attachment mechanisms described herein or known in the art.

The module housing member 44, 44b, the first housing member 48, the second housing member 52, the guide member 120, the removable plug member 92, and the mounting arm 20 may be formed from various materials known in the art such as steel or plastic, for example, and may be forged, cast, molded, or formed in any of a variety of ways known in the art.

### INDUSTRIAL APPLICABILITY

In operation, and with specific reference to the embodiment shown in FIGS. 1 and 2, pressurized fluid may be applied to or removed from internal portions of the fluid cylinder 18 via ports 26a, 26b, thereby causing extension or retraction of the piston and rod assembly 22 within cylinder 18. Such extension or retraction will cause corresponding movement of the second sensor portion 60 (FIG. 2) (via the second housing member 52) relative to the first sensor portion 56 (via the first housing member 48). As described above, interaction between the sensor components 60, 56 allows the position sensor assembly to electronically register a position of the second sensor portion 60 relative to the first sensor portion 56. Moreover, the registered position ultimately represents the position of the piston and rod assembly 22 relative to the cylinder 18 since the second sensor portion 60 moves with the piston and rod assembly 22 and the first sensor portion 56 moves with the cylinder 18.

The position sensor assembly 10 described in the foregoing paragraphs provides a robust device that is externally mountable to a linkage 14 system for determining the position of a first linkage member relative to a second linkage member. The position sensor assembly 10 may be configured and arranged to enclose and protect various sensor components from external conditions, such as dirt and debris, and may therefore be used in a variety of otherwise prohibitive conditions. For example, the disclosed position sensor assembly 10 may be mounted directly to earthmoving machines and used during excavating operations.

The disclosed position sensor assembly 10 may be adaptable to many different configurations and types of linkage systems 14. For example, because the sensor portions 56, 60 of the position sensor assembly 10 may each be externally mountable relative to a linkage system 14, the disclosed assembly 10 may be used with ferrous or non-ferrous hydraulic cylinders 18. In addition, the position sensor assembly 10 may be mounted in a variety of orientations relative to a linkage system 10. For example, the assembly 10 may be mounted in a spaced-apart relationship relative to a linkage system 14 so that close proximity of the sensor portions 56, 60 relative to the linkage members is not required. Further, the position sensor assembly 10 may be applied to new linkage systems 14, or the assembly 10 may be applied to existing/older linkage systems 14 that have less accurate or no position sensing capability.

Moreover, the disclosed position sensor assembly 10 may provide a self-aligning mounting feature to facilitate accurate and efficient mounting and alignment of the assembly 10 to a linkage system 14. Such self-alignment may prevent or limit alignment problems in the field, where access to mounting or alignment tools may be limited.

From the foregoing it will be appreciated that, although specific embodiments of the invention have been described herein for purposes of illustration, various modifications may be made without deviating from the spirit or scope of the invention. Other embodiments of the invention will be apparent to those skilled in the art from consideration of the specification and figures and practice of the invention disclosed herein. It is intended that the specification and examples be considered as exemplary only, with a true scope and spirit of the invention being indicated by the following claims and their equivalents. Accordingly, the invention is not limited except as by the appended claims.

1. A position sensor assembly adapted to mount externally to a linkage system, the position sensor assembly comprising:
a first sensor housing member adapted for external connection to the linkage system and having a first sensor conduit therein;
a second sensor housing member slidably received within the first sensor housing member and having a second sensor conduit therein;
a first sensor portion connected with the first sensor housing member; and
a second sensor portion connected with the second sensor housing member;
wherein:
the first sensor housing member is configured and arranged to at least partially enclose the first sensor portion and the second sensor portion; and
the position sensor assembly is operable to register a position of the first sensor portion relative to the second sensor portion as a result of cooperation between the first and second sensor portions.

2. The position sensor assembly of claim 1, wherein:
the second sensor housing member is telescopically received within the first sensor housing member.

3. The position sensor assembly of claim 1, wherein:
the first and second sensor housing members comprise first and second tubes, respectively, the second tube being telescopically received within the first tube.

4. The position sensor assembly of claim 3, wherein the first and second tubes have generally circular cross-sectional shapes.

5. The position sensor assembly of claim 1, wherein:
the first sensor portion is disposed generally parallel to or coaxially with the second sensor conduit and is configured and arranged to be movable within the second sensor conduit during operation of the position sensor assembly.

6. The position sensor assembly of claim 1, wherein the first sensor portion is arranged in a telescopically movable configuration relative to the second sensor portion.

7. The position sensor assembly of claim 1, further comprising a wiper element attached to the first sensor housing member.

8. The position sensor assembly of claim 1, further comprising:
a module housing member connected to at least one of the first and second sensor housing members; and
a sensor module operably connected to at least one of the first and second sensor portions and at least partially encased within the module housing member.

9. The position sensor assembly of claim 8, further comprising a connector operably connected to the sensor module and at least partially encased within the module housing member.

10. A linkage and sensor system comprising:
a first linkage member;
a second linkage member movably connected to the first linkage member;
a position sensor assembly externally connected to the first and second linkage members, the position sensor assembly comprising:
a first sensor housing member externally connected with one of the first and second linkage members and having a first sensor conduit therein;
a second sensor housing member externally connected to the other of the first and second linkage members and slidably received within the first sensor housing member, the second sensor housing member having a second sensor conduit therein;
a first sensor portion connected with the first sensor housing member; and
a second sensor portion connected with the second sensor housing member;
wherein:
the first sensor housing member is configured and arranged to at least partially enclose the first sensor portion and the second sensor portion; and
the position sensor assembly is operative to register a position of the first linkage member relative to the second linkage member as a result of cooperation between the first and second sensor portions.

11. The linkage and sensor system of claim 10, wherein:
the second sensor housing member is telescopically received within the first sensor housing member.

12. The linkage and sensor system of claim 10, wherein:
the first and second sensor housing members comprise first and second tubes, respectively, the second tube being telescopically received within the first tube.

13. The linkage and sensor system of claim 12, wherein the first and second tubes have generally circular cross-sectional shapes.

14. The linkage and sensor system of claim 10, wherein:
the first sensor portion is disposed generally parallel to or coaxially with the second sensor conduit and is configured and arranged to be movable within the second sensor conduit during operation of the linkage and sensor system.

15. The linkage and sensor system of claim 14, further comprising a sensor guide member attached to the first sensor portion between the first sensor portion and the second sensor housing member, the sensor guide member being operative to limit or at least inhibit contact between the first sensor portion and the second sensor housing member.

16. The linkage and sensor system of claim 10, wherein the first sensor portion is arranged in a telescopically movable configuration relative to the second sensor portion.

17. The linkage and sensor system of claim 10, further comprising a wiper element attached to the first sensor housing member.

18. A linkage and sensor system comprising:
a first linkage member;
a second linkage member movably connected to the first linkage member; and
a self-aligning position sensor assembly connected with the first and second linkage members, the position sensor assembly comprising a first sensor portion operatively connected to the first linkage member;
a second sensor portion operatively connected to the second linkage member;
a sensor housing member at least partially enclosing at least one of the first and second sensor portions; and
at least one self-aligning mounting member connecting the sensor housing member externally to the first linkage member;
wherein:
the at least one self-aligning mounting member is operable to align the sensor housing member in a predetermined orientation relative to the first linkage member during assembly of the sensor housing member with the first linkage member; and
the position sensor assembly is operative to register a position of the first linkage member relative to the second linkage member as a result of cooperation between the first and second sensor portions.

19. The linkage and sensor system of claim 18, wherein the at least one self-aligning mounting member has a contoured mounting surface configured for alignment with an external portion of the first linkage member.

20. The linkage and sensor system of claim 18, wherein the at least one self-aligning mounting member is operable to align the sensor housing member in a generally parallel and spaced apart relationship relative to the first linkage member.

21. The linkage and sensor system of claim 18, further comprising a sensor member operably connected between the second sensor portion and the second linkage member and telescopically received within the sensor housing member.

22. The linkage and sensor system of claim 18, wherein:
the first linkage member has a cylindrical portion; and
the contoured mounting surface of the at least one self-aligning mounting member has a curved portion that generally conforms to the outer surface of the cylindrical portion.

23. The linkage and sensor system of claim 18, wherein the position sensor assembly comprises at least two spaced apart self-aligning mounting members.

24. A method of determining the position of a first linkage member relative to a second linkage member, the method comprising:
adapting the first linkage member with a first sensor portion at least partially enclosed by a first sensor housing member, wherein the first sensor portion and the first sensor housing member are externally disposed relative to the first and second linkage members;
adapting the second linkage member with a second sensor portion that is connected to a second sensor housing member and that is at least partially enclosed by the first sensor housing member, wherein the second sensor portion and the second sensor housing member are externally disposed relative to the first and second linkage members;
moving the first linkage member relative to the second linkage member;
causing the first sensor housing member to enclosingly and slidably receive the second sensor housing member, wherein the first sensor portion is in a telescopically movable relationship relative to the second sensor portion; and
causing the position sensor assembly to register a position of the first linkage member relative to the second linkage member as a result of cooperation between the first and second sensor portions.
